(19) United States
(12) Patent Application Publication
(10) Pub. No.: US 2003/0018623 A1
(43) Pub. Date: Jan. 23, 2003

(54) System and method of query processing of time variant objects

(75) Inventors: Charu Aggarwal, Yorktown Heights, NY (US); Dakshi Agrawal, Croton on Hudson, NY (US)

Correspondence Address: Louis P. Herzberg, Intellectual Property Law Dept., IBM Corporation, P.O. Box 218, Yorktown Heights, NY, 10598, US

(73) Assignee: International Business Machines Corporation, Armonk, NY

(21) Appl. No.: 09/908,336

(22) Filed: Jul. 18, 2001

(51) Int. Cl. G06F 7/00

(52) U.S. Cl. 707/3

(57) ABSTRACT

The present invention provides a method for query processing of time variant objects. In order to achieve this, we create an efficient index structure on a parametric representation of the relevant attributes of objects. The method particularly relates to resolving different kinds of queries such as nearest neighbor query and range query. Such a technique can be used to efficiently retrieve objects in a very large database of objects whose attributes are both complex and varying with time. The technique can handle complex objects which have multiple attributes evolving possibly nonlinearly with time. Such a method can be used in applications that track mobile objects or it can be used in supermarket applications which track the evolution of consumer traits.

### FIELD OF THE INVENTION

The present invention relates to query processing of time variant objects. It is more particularly related to systems and methods to perform different kinds of queries.

### BACKGROUND OF THE INVENTION

A time variant object has attributes that change with time. Time variant objects occur naturally in a number of domains, for example, in Geographical Information Systems (GIS), in radar tracking, and electronic commerce applications. In GIS, time variant objects could be automotives, and their relevant attribute could be their position. In radar tracking, time variant objects could be airplanes, and their relevant attribute could be their position. In electronic commerce applications, the relevant objects could be clients-profiles, and relevant attributes could be bandwidth usage, and/or disk space. In general, a time variant object may have multiple relevant attributes. We assume that these attributes can be mapped to a point in n-dimensional real-space. Let f(t) denote the relevant attribute(s) of the time variant object at time ‘t’. The functional form of attribute function f(t) may change from time to time.

In many applications, it is desirable to query a set of time variant objects for various purposes. In the present invention, we will discuss methods for querying time variant objects. Some classes of such queries are as follows:

1. For a given target object with attribute-value O, find all objects with attribute-value closest to ‘O’ at a future time ‘t’. (Point Nearest Neighbor Query)

2. For a given target hyperplane P of attributes, find all objects which are closest to P at a future time ‘t’. (Hyperplane Nearest Neighbor Query)

3. Find all the objects whose attribute lie within a user specified range ‘R’ at a future time ‘t’. (Range Queries)

Some examples of querying time variant objects are as follows:

1. In a geographical information system (GIS), we may have a large number of vehicles which are moving in various trajectories. We wish to find all those vehicles which lie in a certain region at a future time ‘t’ to detect congestion. Here each vehicle is an object and its relevant (tracked) attribute is its position. This is an example of Range Query.

2. In a radar tracking application, we may have a large number of airplanes whose positions are being simultaneously tracked. At a given moment in time, we would like to find all the airplanes which are closest to a target location. Here, each airplane is an object, and similar to the previous example, the relevant attribute of the objects is their positions. This is an example of Point Query.

3. In an e-commerce application, we may be interested in the number of clients that will have two times the bandwidth plus disk-storage exceeding a certain limit L. Here the attribute is two dimensional, one dimension for bandwidth and another for disk-storage.

4. In mobile communication, we may be interested in the number of cell-phone in a given area at a future time ‘t’ to plan adequate capacity. This is an example of Range Query.

5. In space travel, we may be interested in knowing the position and identity of the space-junk closest to a space-shuttle.

6. In a semiconductor chip, insulation between wires may become thin with the passing of time. We may be interested in knowing if the insulation would be lower than a certain value at a future time ‘t’.

Note that querying a time varying object could be a part of a compound query. Most indexing work has been on indexing sets of static objects such as in [RSTAR]. RSTAR is described in, “The R*-Tree: An Efficient and Robust Method for Points and Rectangles,” Beckman, N., Kriegel, H., Schneider, R., Seeger, B., Proceedings of the ACM SIGMOD Conference, 1990, 322—331, 1990, which is incorporated herein in entirety by reference for all purposes. In the method of [RSTAR] a hierarchical tree structure is built such that closely clustered objects occur in each node of the tree. A minimum bounding rectangle is associated with each node. This rectangle characterizes the objects which are located within that node and is useful for searching purposes. Those skilled in the art will appreciate that there is considerable choice and flexibility in building such a hierarchical index structure. Such work does not deal with the problem of objects whose attributes evolve with time. For time variant objects, querying is generally limited to queries in one or two dimensions for objects whose attribute evolve linearly with time. It would be advantageous to be able to handle a wide variety of queries on objects whose attributes evolve non-linearly and in multiple dimensions.

For the ease of exposition, we define a complex attribute as used herein to include an attribute that evolves linearly or non-linearly and/or in single or multiple dimensions. Correspondingly, the term complex trajectory is used to describe a function which provides values that a set of such complex attributes takes with time. The word object as used herein includes items, components, prices, files, data sets, and databases, vehicles, particles, etc.

### SUMMARY OF THE INVENTION

One aspect of the present invention is to provide methods, apparatus and systems to handle, resolve and respond to a wide variety of queries on objects whose attributes evolve linearly or non-linearly and/or in single or multiple dimensions. Correspondingly. Another aspect of the invention provides the ability to describe the complex trajectory to provide values that a set of such complex attributes takes with time, for an object type.

Thus example, the present invention provides the ability to track an incoming ballistic missile having nonlinear parabolic trajectory. It provides the ability to track, query and respond to queries in a user profile populated with more than two time varying attributes: disk space, process time, and number of emails received, number of chat-sessions conducted.

### DESCRIPTION OF THE DRAWINGS

These and other objects, features, and advantages of the present invention will become apparent upon further consideration of the following detailed description of the invention when read in conjunction with the drawing figures, in which:

FIG. 1 is an example illustration of an architecture for the present invention;

FIG. 2 is an example of a flow diagram for building an entire index structure from the parametric representations of attributes and how it is employed to resolve user queries in accordance with the present invention;

FIG. 3 is an example flow diagram showing a process of determining an object which is closest to a specified target at a specified time;

FIG. 4 is an example flow diagram showing a process of determining a response to a range query;

FIG. 5 is an example flow diagrams showing how the distance of the convex hull to a given target point is determined;

FIG. 6 is an example illustration of an apparatus for efficient query of time variant objects with complex attributes;

FIG. 7 is an example illustration of an apparatus for efficient query of time variant objects with complex attributes.

### DETAILED DESCRIPTION OF PREFERRED EMBODIMENT

The present invention, provides methods, apparatus and systems for query processing of time-variant objects. Techniques are provided which determine results to range queries, nearest neighbors queries, and/or hyperplane queries. In order to resolve the queries, we use a carefully chosen parametric representation of the attribute space. In this representation, each attribute of the object at a specified time may be determined by a set of parameters and the specified time.

For example, consider an object which is moving in a straight line. Then, the location of the object at time ‘t’ may be given as follows:

x(t)=s+v.t

Here x(t) is the location of the object at time t, v is its velocity, and s is its initial position. Note that for an object moving in k dimensions, the values of v and s are k-dimensional as well. Correspondingly, the coordinate (v, s) represents a 2k-dimensional parameters that determine the location of the object at any specified time ‘t’.

As another example, consider an object, such as ballistic missiles or space junk, falling under the effect of gravity. Its location evolves non-linearly with time and is given by:

x(t)=sx+vx.t

Y(t)=sy+vy.t+G.t.t

Here sx and sy are initial horizontal and vertical positions of the object respectively, and vx and vy are initial horizontal and vertical velocities respectively. G denotes acceleration due to gravity. In this case, the parametric representation of the position of the object is given by a 4-dimensional vector corresponding to (sx, sy, vx, vy). Note that the vertical position of the object evolves non-linearly with time.

In the present invention, we discuss ways of querying at least one time variant object having at least one known complex attribute. This is accomplished by a careful traversal of a multidimensional index tree constructed by using the representations of the attributes of objects. We shall henceforth refer to the parametric representation of an object ‘O’ by P(O). Similarly, the value of the attribute of the object ‘O’ at time ‘t’ is denoted by f(O, t).

Firstly, the parametric representations of the various objects are chosen. These representations are inserted them into a multidimensional index structure. Note that the trajectory of an attribute of an object may change. In this case, the corresponding parametric representation of the object also changes. Should this happen, the old representation of the object is removed from the index structure and the new representation is inserted. Many multidimensional index structures can be used for this purpose, such as the R-Tree, R*-Tree [RSTAR].

Since we use the concept of index structure frequently in this patent, we will now introduce the details of this structure. A multidimensional index structure is a static hierarchical partitioning of the data (data, in this case, is the parameteric representation of the attributes of all objects). At the top of this hierarchy is the node called the root, which is partitioned into smaller nodes. These smaller nodes are successively partitioned into smaller nodes, thus generating an index tree. The criteria for partitioning the node depend on the specific index structure and may be implemented as is well-known to those familiar with the art, for example as in [RSTAR]. The nodes of an index tree structure are of two types: internal nodes and leaf nodes. Internal nodes are partitioned further and they include pointers to the lower nodes. On the other hand, leaf nodes are not partitioned and each leaf node includes the aforementioned parametric representation of attributes of a small subset of objects. The lower level nodes, to which an internal node points, are referred to as children nodes. We assume that each of the nodes in the index structure has a minimum bounding rectangle (MBR) in which the parametric representation of attributes of all its descendent objects lie. Multidimensional index structures provide an effective hierarchical representation of the data which can be used for efficient querying. Recognition of the fact that each level of the hierarchy is a strict superset of those below is very useful for the purpose of traversal and search.

Once the parametric representations of the attributes of objects have been inserted into this index structure, we use a tree traversal method in order to actually resolve the query. The process of resolving a query is essentially the step of processing the data so that the solutions best fitting the query parameters are returned. We note that the step of resolving a query includes the step of resolving a compound query. A compound query is defined as any query which can be created by a combination of any of the queries discussed herein. The entire method of traversal uses a branch and bound technique which will be described in detail in the subsequent description of the invention.

The method described relies upon on an important property which we refer to as the convex hull property. The convex hull property is as follows: Let O(1), . . . O(n) be ‘n’ objects. Let ‘O’ be an arbitrary object. Let the parametric representation of its attributes, P(O) lie in the convex hull of P(O(1)), . . . , P(O(n)), parametric representations of O(1), . . . , O(n). Then the convex hull property implies that the attribute of object ‘O’ at time t, given by f(O, t), lies in the convex hull of f(O(1), t). . . f(O(n), t).

A large number of attributes satisfy this convex hull property. For example, many natural trajectories involving velocity and acceleration, including the examples given above, satisfy this property. The present invention is capable of querying all objects which satisfy the convex hull property.

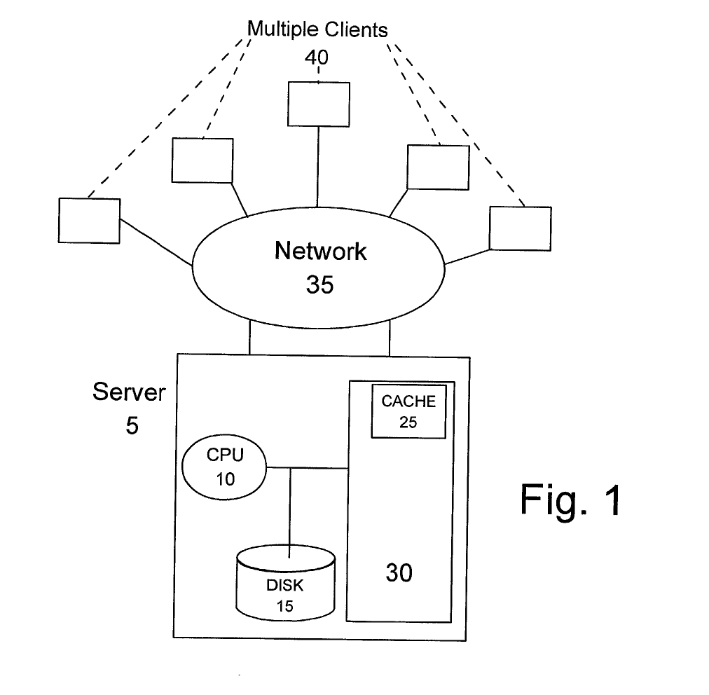

FIG. 1 is a description of an architecture for an example embodiment present invention. It is assumed that multiple clients (40) are connected to the server (5) over a network (35). It is assumed that the server includes data about a large number of sets of objects which is used in the queries. Specific queries along with the corresponding data sets are specified at the client end. These requests are then resolved and responded to using the software at the server end. The computation is performed by the CPU (10). The data on which the analysis is carried out may already be available at the server on its disk(15). The index structure is built on this disk and is used for the purpose of the queries. We assume that a main memory (30) and cache (25) is available at the server end in order to speed up the computations.

In either case, the computation is performed at the server end, and the results are returned to the client for this embodiment. This flexible architecture allows multiple clients to access an index at the same time. Note that this architecture is only one of the architectures in which the present invention can be employed. It would be clear to those skilled in art that the present invention can also be used when queries are generated at the server site in response to perform a specific task. For example, at an internet service provider (ISP), it may be necessary to obtain profiles of the users who will exceed their quotas of disk space and number of emails two weeks from now, so that a warning may be sent. In this case, the query are generated at the ISP site and the data is also stored at the ISP site.

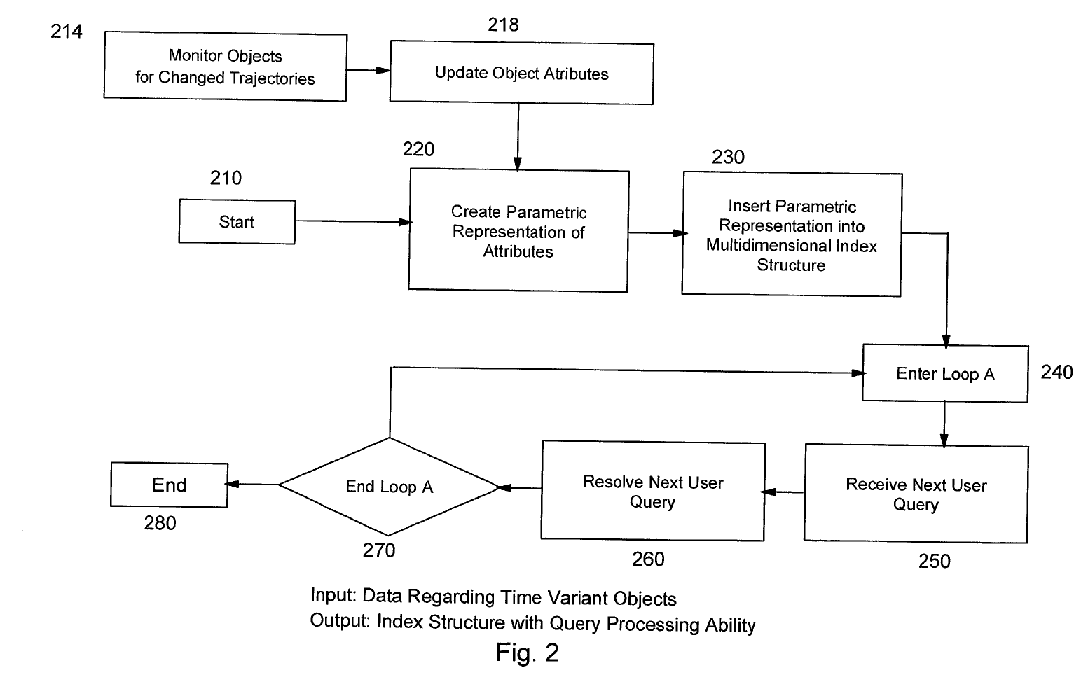

FIG. 2 provides an overall description of how the invention works in terms of its query processing ability. The input to the system of FIG. 2 is data regarding time variant objects, which we refer to as the complex attributes of these objects. The output is an index structure with query processing ability. We note that the system shown in FIG. 2 is well defined for these complex attributes, where complex attributes are defined as discussed earlier.

In step 210, the process for creating index structure is started. In step 214, the objects are monitored for any change in trajectories. If there are any changes in the trajectory then corresponding object attributes are updated in step 218. Next, the user creates a parametric representation of attributes in step 220. This parameteric representation should satisfy the convex hull property mentioned above. For example, when the tracked attribute is position of an object which is moving in a straight line given by s+v.t, a suitable parametric representation of the position is given by (s,v). In general, any parameters from the functional representation of the complex attribute may be used at step 220 as long as it satisfies above mentioned convex hull property. Once suitable parametric representations have been created, we insert them into a multidimensional index tree structure in step 230. This multidimensional index tree structure could be any of the methods discussed in the prior art such as R-Trees, R+-Trees, R*-Trees etc [RSTAR]. In steps 240 through 270, we set up a loop in which we receive the various user queries and resolve them with the help of this index structure. The process ends in step 280.

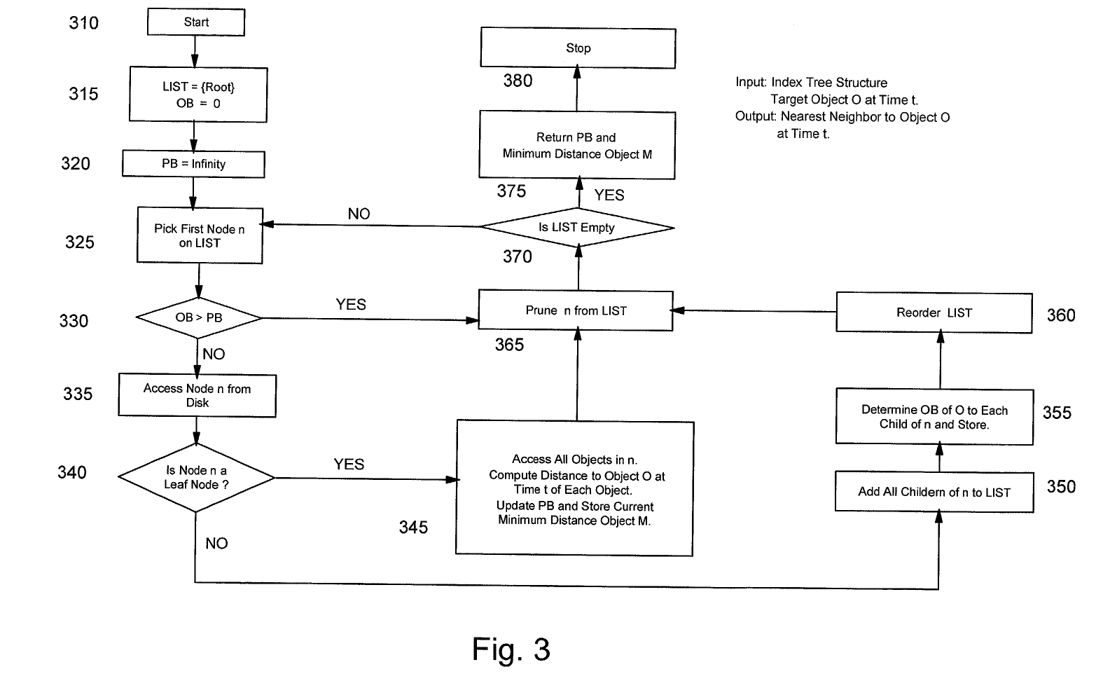

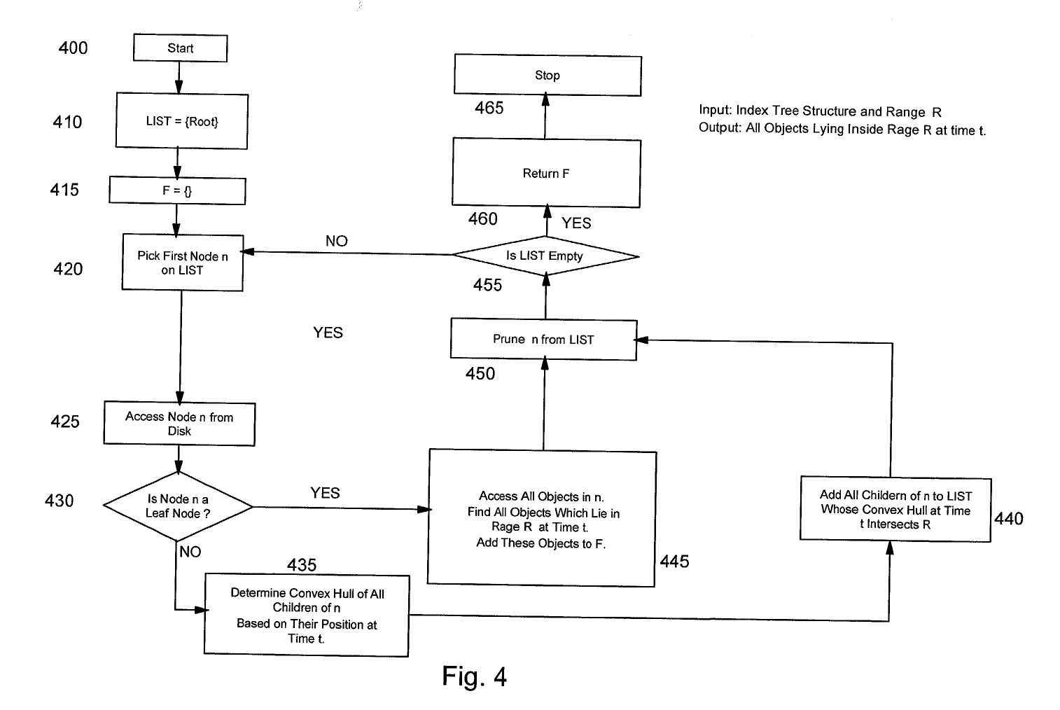

The query of step 250 could be of various types; for example it could be a nearest neighbor query in which a user specifies a target object and a future time t, and we wish to find the nearest neighbor to the object at time ‘t’. In FIGS. 3 and 4, we will provide details of the processing of two different kinds of queries: the nearest neighbor query and the range query. The details of hyperplane nearest neighbor query are similar. In this case, instead of using the target object in order to calculate the nearest neighbor distances, we use the target hyperplane for the same calculations.

We note that the technique of creation of the index tree includes the ability to update the objects when one or more of the complex attributes and/or trajectories change. Step 214 of FIG. 2 shows a monitoring system that is capable of providing a diagnostic signal when a change of at least one particular attribute from the said at least one complex attribute has occurred. Such a monitoring system could be an automated system or may be driven by human intervention. Based on the results of this step, relevant object attributes are updated step 218, and a second representation is created in step 220. Subsequently, the new representation is inserted in the multidimensional index structure and the old one is removed. This updated structure is then passed to step 240, which uses it in step 250 and step 260 to resolve user queries.

FIG. 3 is an example flow diagram showing the steps of an embodiment for resolving and processing a nearest neighbor query for a future specified time ‘t’. This is one of the kinds of queries referred to in items 250 and 260 of FIG. 2. The input to the system is the multidimensional index tree structure of the parametric representation of the objects, the target object ‘O’, and a specified time ‘t’. The output is the object whose attributes are closest to the attributes of the target object ‘O’ at the time ‘t’. This is herein called a nearest neighbor query. In order to perform the nearest neighbor query, we start in step 310 and maintain a set of objects in the form of a LIST which is the set of nodes that needs to be traversed. The value of LIST keeps track of all the nodes which have been visited thus far. Thus, the LIST provides an effective way for book keeping during the multidimensional index tree traversal. In step 315, we initialize the value of LIST to the root of the multidimensional index structure. At each point in this flow, we also maintain a parameter called pessimistic bound, denoted by PB. Pessimistic bound refers to the distance between the attribute of the target object ‘O’ and the closest value of attribute of all objects accessed so far at the time ‘t’. This bound is set to infinity in the beginning in step 320, when none of the objects have been accessed. At the same time, we also maintain an optimistic bound for each node visited. The optimistic bound is a lower bound on the distance between the query point and any object in that node at a given time instant. Initially, the optimistic bound is set to ‘O’ for the root node in the step 315. In step 325, we pick the first node on LIST. In step 330, we check if the optimistic bound to the node is larger than the pessimistic bound to any object encountered so far. We note that this optimistic bound was set at the time the node ‘n’ was added to LIST. If this is not the case, then the subtree rooted at node ‘n’ needs to be explored further in step 335, otherwise we jump to step 365 and prune the node ‘n’ from LIST. In step 335, we access the node ‘n’ from disk. We check if this node ‘n’ is a leaf node in step 340. If the node ‘n’ is a leaf node, then we access all the objects in ‘n’ and compute the distance of each object in ‘n’ to object ‘O’ at the time ‘t’. If the minimum of these distances is less than the pessimistic bound, then we update the pessimistic bound to the minimum of these distances and store the corresponding object as the current minimum distance object M. This is done in step 345. If node ‘n’ is not a leaf node, then we add all children of node ‘n’ to LIST in step 350. In step 355, we determine the optimistic bound OB for the object ‘O’ to all children of ‘n’ and store OB along with these nodes in LIST.

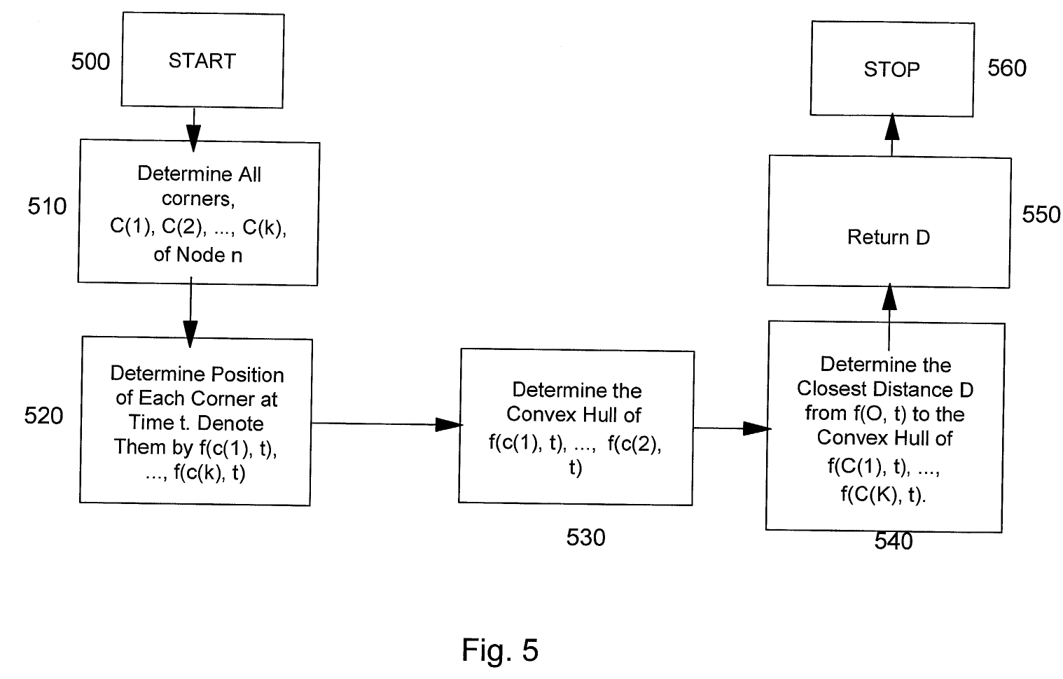

The process of determining the optimistic bound will be described in detail in FIG. 5. Node ‘n’ and target object ‘O’ are the inputs of FIG. 5. The output is an optimistic bound ‘OB’ to node ‘n’. We note that the ordering of the LIST determines the traversal strategy of the tree. The present invention does not restrict the method for choosing LIST ordering. Examples of effective LIST reordering include the use of the optimistic bound to each node in order to sort the nodes by their distances to the target. The reordering of the LIST is done in step 360. In step 365, we delete the node ‘n’ from LIST. We check if the LIST is empty in step 370. If this is the case, then we return the pessimistic bound and the minimum distance object M in step 375 and stop in step 380

FIG. 4 is a flow diagram showing an example embodiment for a process of performing a range query on the target object. This is another kind of the queries referred to in items 250 and 260 of FIG. 2. The input to the system is the multidimensional index structure and the range ‘R’ at time ‘t’. The output includes all objects lying inside range ‘R’ at time ‘t’. In this case, we start 400 and again maintain the set of nodes in LIST 410. As in the case of the nearest neighbor query, we initialize the value of LIST to the root node of the index structure in step 410. In step 415, we initialize the set F to { } which is the null set. The set F will include the final set of objects which are returned as a result of the range query. In step 420, we pick the first node ‘n’ from LIST. This node is accessed from the disk in step 425. In step 430, we check if the node ‘n’ is a leaf node. This information is available from the nodes in the multidimensional index structure. If the node is a leaf node, then we access all objects in ‘n’ and find those which lie in the range ‘R’ at time ‘t’. These objects are added to F since these are valid responses to the corresponding range query. This is done in step 445. On the other hand, if the node ‘n’ is not a leaf node, then we determine the convex hulls of all children of node ‘n’ based on their position at time ‘t’. This is done in step 435. At this point, we add those children of ‘n’ to LIST whose convex hulls at time ‘t’ intersect ‘R’ in step 440. Subsequently, in step 450, we delete the node ‘n’ from LIST. Next, in step 455, we check if LIST is empty. If this is indeed the case, then we return the set F in step 460 and terminate in step 465. Otherwise, we return to step 420 and continue the process of exploring the multidimensional index structure further.

FIG. 5 shows a flow diagram of an example embodiment for the detailed steps for determining the optimistic bound of the target object to any node n. A node ‘n’ and target object ‘O’ are the inputs given in step 500 of FIG. 5. The output is an optimistic bound ‘OB’ to node ‘n’. In step 510, we determine all the corners of node n. These are effectively the corners of the Minimum Bounding Rectangle (MBR) of node n. We denote these corners by C(1), . . . , C(k). We determine the position of each of these corners C(1), . . . , C(k) at time ‘t’ in step 520. We used the trajectory function in order to determine the position of these objects at time ‘t’. These positions are denoted by f(C(1),t, . . . ,f(C(k), t). In step 530, we determine the convex hull of the set of points f(C(1), t), . . . f(C(k), t) employing any method for finding the convex hull of a set of points. Many methods are known to those familiar with the art. Next, in step 540, we determine the closest distance D of f(O, t) to the convex hull of f(C(1), t), . . . , f(C(k), t). This distance D is returned as the optimistic bound to node ‘n’ in step 550 and the process terminates in step 560. This distance bound in conjunction with the local pessimistic bound is used for the purpose of pruning in step 365 of FIG. 3.

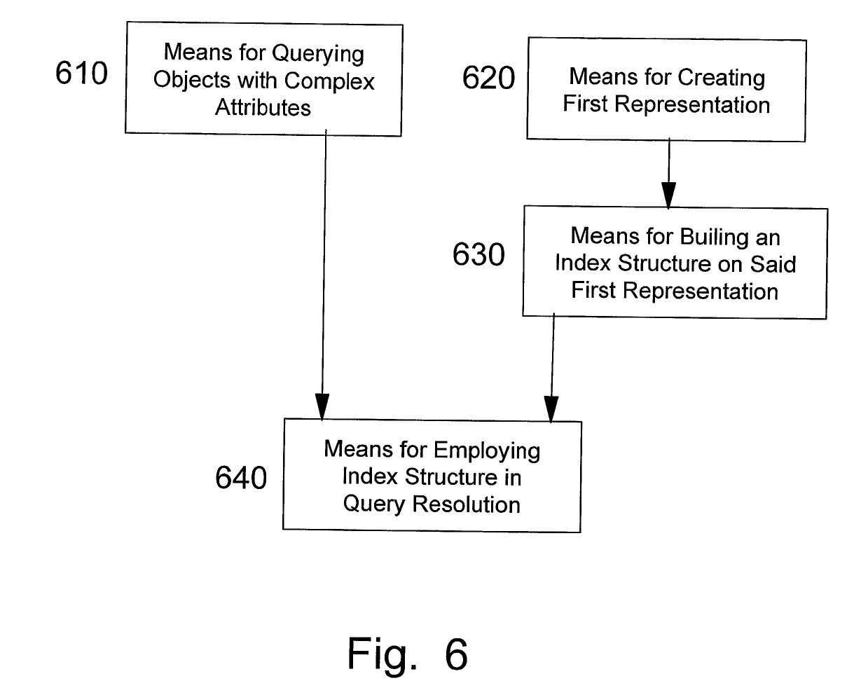

FIG. 6 shows an example embodiment of an apparatus employed for efficient query of time variant objects with complex attributes in accordance with the present invention. It includes means of querying objects with complex attributes (610) and means for creating a first representation of attributes of the objects (620). We note that representations of attributes generally satisfy the convexity property discussed above. This apparatus also includes means for building an index structure on the said first representations of the objects (630). Note that the index structure is updated if the trajectories of objects change with time. Finally, the apparatus has means for employing index structure (640) in order to resolve a query.

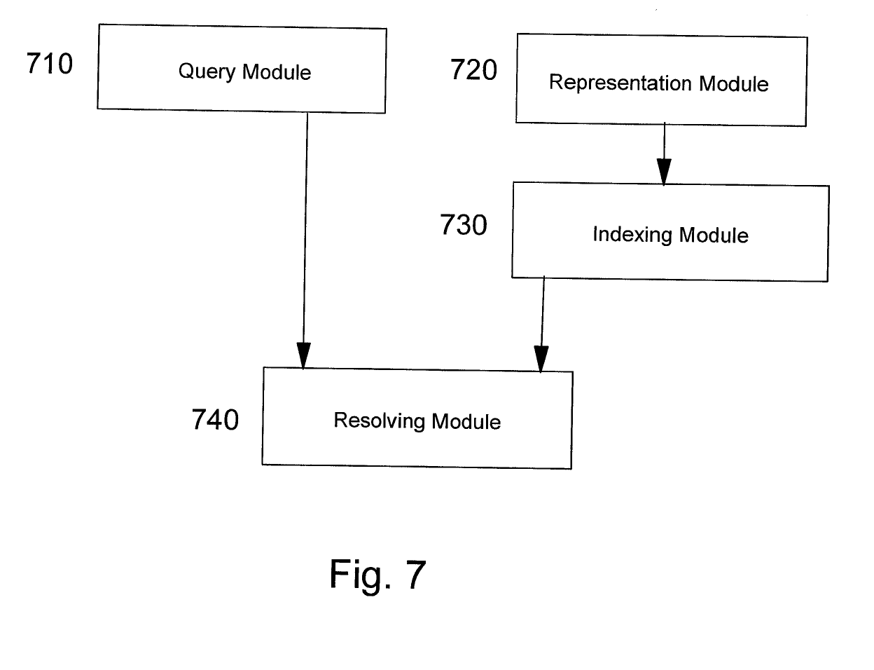

FIG. 7 is another example embodiment of an apparatus employed for efficient query of time variant objects with complex attributes in accordance with the present invention. It includes a query module (710) to generate queries for objects with complex attributes. It also has a representation module (720) for generating a first representation of attributes of the objects. We note that representations of attributes generally satisfy convexity property discussed above. The apparatus also has an indexing module (730) for building an index structure on the said first representations of the objects. Finally, the apparatus has a resolving module (740) for employing index structure in order to resolve a query.

Thus, the present invention includes a method for querying at least one time variant object having at least one known complex attribute, creating a first representation of the ‘at least one time variant object’ in terms of the ‘at least one known complex attribute’, building an index structure on said first representation, and employing the index structure in resolving at least one query included in the step of querying. The overall process for this method is illustrated in the different steps of FIG. 2. Specifically, step 220 of FIG. 2 illustrates the process of the creation of the first representation of the object having at least one known complex attribute. Step 230 of FIG. 2 illustrates the process of building an index structure on said first representation, whereas steps 250 and 260 show the process of resolution of user queries. We also note that the step of querying at least one time variant object sometimes includes obtaining a problem in search of a resolution. This is shown in the step 240 and step 270 of the FIG. 2.

In some embodiments, step 220 of FIG. 2 of creating a first representation of the ‘at least one time variant object’ includes maintaining a convexity property of the first representation and at least one known complex attribute. The convexity property indicates that all the objects within the convex hull of the first representation continue to stay in the convex hull when the snapshot of their attributes is taken at any future time ‘t’.

As discussed in this embodiment, it is often the case that the trajectories of the objects may change to some extent. In cases when the trajectory changes, it may be necessary to update the representations of these objects. In this case the method often includes updating at least one particular attribute from the ‘at least one complex attribute’ as shown in step 218 of FIG. 2. In some cases, the step of updating includes creating a second representation of the ‘at least one time variant object’ based on a result from the step of updating as shown in step 220 of FIG. 2. This second representation is essentially similar to the first representation discussed above, except that in this case the updated attributes are used in order to create the representation. In order to create the change it is sometimes advantageous to further monitor a change of at least one particular attribute from the ‘at least one complex attribute’ as shown in step 214 of FIG. 2. This process of monitoring is most often automated but is sometimes initiated by a human. In either case, the invention may be used in a manner which to incorporates all these variations.

Once the process of monitoring has been completed, the method sometimes includes the step of updating at least one particular attribute from the ‘at least one complex attribute’ based on the change, and also includes creating a second representation of the ‘at least one time variant object’ based on a result from the step of updating, as shown in step 214 and step 218 of FIG. 2 respectively.

In many of these embodiments the index structure is thus a dynamically updated structure which keeps track of the most current trajectories. This updated index structure is now employed for the purpose of querying. Sometimes, the step of employing the index structure includes finding at least one closest object to a target object at a specified time. An example illustration of employing a multidimensional index structure to find at least one closest object to a target object at a specified time is given in step 260 of FIG. 2.

In some embodiments the step of finding this closest object as discussed above includes using a tree traversal method on the multidimensional index structure to find at least one closest object to a target object at a specified time. An example illustration of the process of tree traversal is shown in detail in FIG. 3.

The step of employing the index structure, is illustrated in step 260 of FIG. 2, sometimes includes finding at least one object within a specified range at a specified time. This is known as resolving a range query. In range queries, the step of finding sometimes also includes using a tree traversal method on a multidimensional index structure to find at least one object within a specified range at a specified time. This tree traversal method traverses a node only if the user specified range intersects with the node in the tree. An example illustration of this tree traversal method is shown and described regarding FIG. 4.

In some embodiments, the step of employing the index structure, shown in step 260 of FIG. 2, includes finding at least one object that is closest to a given hyperplane at a specified time. The step of finding sometimes includes using a tree traversal method on a multidimensional index structure to find at least one object closest to the given hyperplane at the specified time. We note that the query processing method for finding all the objects closest to a given hyperplane is similar to that of finding all the objects closest to a given target as illustrated in FIG. 3. The difference is that in this case the distance to a hyperplane is used for the process of pruning in step 365 of FIG. 3. Those skilled in the art can appreciate that the present invention, including the multidimensional index traversal method illustrated in FIG. 3, is applicable to a wide variety of scenarios, such as hyperplanes, curved or arbitrary shaped multidimensional linear subspaces, etc., for the purpose of querying.

In some embodiments, the step of traversing the multidimensional index structure includes pruning at least one branch of the multidimensional index structure. Two examples illustration of this pruning are shown in step 330 of FIG. 3 and in step 490 of FIG. 4. As indicated in FIG. 3, the step of pruning sometimes includes pruning a node when a local optimistic bound is farther away than a global pessimistic bound as shown in step 330 of FIG. 3. Thus, the process of pruning often includes maintaining a global pessimistic bound and a local optimistic bound for each node in said multidimensional index structure, as illustrated in steps 315 and 320 of FIG. 3. The optimistic bound to each relevant node is computed in step 355 of FIG. 3. Note that once the pruning has been completed, we only need to visit those nodes which have not been pruned. Thus the step of finding object closest to a specified hyperplane or to another specified object often includes visiting only those nodes that have not been pruned, as illustrated in step 325 of FIG. 3.

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after conversion to another language, code or notation and/or reproduction in a different material form.

Thus the invention includes an article of manufacture comprising a computer usable medium having computer readable program code means embodied therein for causing a function described above. The computer readable program code means in the article of manufacture comprising computer readable program code means for causing a computer to effect the steps of a method of this invention.

Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention.

Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method comprising:
querying at least one time variant object having at least one known complex attribute;
creating a first representation of said at least one time variant object in terms of said at least one known complex attribute;
building an index structure on said first representation; and
employing said index structure in resolving at least one query included in the step of querying.

2. A method as recited in claim 1, wherein the step of querying at least one time variant object includes obtaining a problem in search of a resolution.

3. A method as recited in claim 1, wherein the step of creating a first representation of said at least one time variant object includes maintaining a convexity property of the said first representation and of the said at least one known complex attribute.

4. A method as recited in claim 1, further comprising updating at least one particular attribute from said at least one complex attribute.

5. A method as recited in claim 4, further comprising creating a second representation of said at least one time variant object based on a result from the step of updating.

6. A method as recited in claim 1, further comprising monitoring a change of at least one particular attribute from said at least one complex attribute.

7. A method as recited in claim 6, further comprising:
updating at least one particular attribute from said at least one complex attribute based on said change, and
creating a second representation of said at least one time variant object based on a result from the step of updating.

8. A method as recited in claim 1, wherein the step of employing said index structure includes finding at least one closest object to a target object at a specified time.

9. A method as recited in claim 8, wherein the step of finding includes using a tree traversal method on a multidimensional index structure to find at least one closest object to a target object at the specified time.

10. A method as recited in claim 1, wherein the step of employing said index structure includes finding at least one object within a specified range at a specified time.

11. A method as recited in claim 10, wherein the step of finding includes using a tree traversal method on a multidimensional index structure to find at least one object within a specified range at a specified time.

12. A method as recited in claim 1, wherein the step of employing said index structure includes finding at least one object that is closest to a given hyperplane at a specified time.

13. A method as recited in claim 12, wherein the step of finding includes using a tree traversal method on a multidimensional index structure to find at least one object closest to the given hyperplane at the specified time.

14. A method as recited in claim 13, further comprising pruning at least one branch of the multidimensional index structure.

15. A method as recited in claim 14, further comprising maintaining a global pessimistic bound and a local optimistic bound for each node in said multidimensional index structure.

16. A method as recited in claim 14, wherein the step of pruning includes pruning a node when a local optimistic bound is farther away than a global pessimistic bound.

17. A method as recited in claim 12, wherein the step of finding includes visiting only those nodes have not been pruned.

18. An article of manufacture comprising a computer usable medium having computer readable program code means embodied therein for causing resolution of at least a portion of a query, the computer readable program code means in said article of manufacture comprising computer readable program code means for causing a computer to effect the steps of claim 1.

19. An apparatus comprising:
means for querying at least one time variant object having at least one known complex attribute;
means for creating a first representation of said at least one time variant object in terms of said at least one known complex attribute;
means for building an index structure on said first representation; and
means for employing said index structure in resolving at least one query included in the step of querying.

20. An apparatus as recited in claim 19, wherein the means for querying at least one time variant object includes means for obtaining a problem in search of a resolution.

21. An apparatus as recited in claim 19, wherein the means for creating a first representation of said at least one time variant object includes means for maintaining a convexity property of the said first representation and of the said at least one known complex attribute.

22. An apparatus as recited in claim 19, further comprising means for updating at least one particular attribute from said at least one complex attribute.

23. An apparatus as recited in claim 22, further comprising creating a second representation of said at least one time variant object based on a result from the means for updating.

24. An apparatus as recited in claim 19, further comprising means for monitoring a change of at least one particular attribute from said at least one complex attribute.

25. An apparatus as recited in claim 24, further comprising:
means for updating at least one particular attribute from said at least one complex attribute based on said change, and
means for creating a second representation of said at least one time variant object based on an update from the means for updating.

26. An apparatus as recited in claim 19, wherein the means for employing said index structure includes means for finding at least one closest object to a target object at a specified time.

27. An apparatus as recited in claim 24, wherein the means for finding employs a tree traversal method on a multidimensional index structure to find at least one closest object to a target object at the specified time.

28. An apparatus as recited in claim 19, wherein the means for employing said index structure includes means for finding at least one object within a specified range at a specified time.

29. An apparatus as recited in claim 28, wherein the means for finding employs a tree traversal method on a multidimensional index structure to find at least one object within a specified range at a specified time.

30. An apparatus as recited in claim 19, wherein the means for employing said index structure includes means for finding at least one object that is closest to a given hyperplane at a specified time.

31. An apparatus as recited in claim 30, wherein the means for finding includes means for using a tree traversal method on a multidimensional index structure to find at least one object closest to the given hyperplane at the specified time.

32. An apparatus as recited in claim 31, further comprising means for pruning at least one branch of the multidimensional index structure.

33. An apparatus as recited in claim 32, further comprising means for maintaining a global pessimistic bound and a local optimistic bound for each node in said multidimensional index structure.

34. An apparatus as recited in claim 32, wherein the means for pruning includes means for pruning a node when a local optimistic bound is farther away than a global pessimistic bound.

35. An apparatus as recited in claim 30, wherein the means for finding includes means for visiting only those nodes have not been pruned.

36. An article of manufacture comprising a computer usable medium having computer readable program code means embodied therein for causing resolution of at least a portion of a query, the computer readable program code means in said article of manufacture comprising computer readable program code means for causing a computer to effect an apparatus of claim 19.

37. An apparatus comprising:
query module to query at least one time variant object having at least one known complex attribute;
a representation module to create a first representation of said at least one time variant object in terms of said at least one known complex attribute;
an indexing module to build an index structure on said first representation; and
a resolving module to employ said index structure in resolving at least one query included in the step of querying.

38. An apparatus of claim 37, wherein the query module obtains a problem regarding at least one time variant object in search of a resolution.

39. An apparatus of claim 37, wherein the representation module maintains a convexity property of the said first representation and of said at least one known complex attribute.

40. An apparatus of claim 37, further comprising an updating module for updating at least one particular attribute from said at least one complex attribute.

41. An apparatus of claim 40, wherein the representation module creates a second representation of said at least one time variant object based on a result from the updating module.

42. An apparatus of claim 37, further comprising a monitor module for monitoring a change of at least one particular attribute from said at least one complex attribute.

43. An apparatus of claim 42, wherein the updating modules updates
at least one particular attribute from said at least one complex attribute based on said change, and
the representation module creates a second representation of said at least one time variant object based on a result from the updating module.

44. An apparatus of claim 37, wherein the resolving module finds at least one closest object to a target object at a specified time.

45. An apparatus of claim 42, wherein the resolving module uses a tree traversal method on a multidimensional index structure to find at least one closest object to a target object at a specified time.

46. An apparatus of claim 37, wherein resolving module finds at least one object within a specified range at a specified time.

47. An apparatus of claim 46, wherein the resolving module uses a tree traversal method on a multidimensional index structure to find at least one object within a specified range at a specified time.

48. An apparatus of claim 37, wherein resolving module finds at least one object that is closest to a given hyperplane at a specified time.

49. An apparatus of claim 48, wherein the resolving module uses a tree traversal method on a multidimensional index structure to find at least one object closest to the given hyperplane at the specified time.

50. An apparatus of claim 49, further comprising a pruning module to prune at least one branch of the multidimensional index structure.

51. An apparatus of claim 50, wherein the resolving module maintains a global pessimistic bound and a local optimistic bound for each node in said multidimensional index structure.

52. An apparatus of claim 50, wherein the pruning module prunes a node when a local optimistic bound is farther away than a global pessimistic bound.

53. An apparatus of claim 50, wherein the resolving module visits only nodes that have not been pruned.

54. An article of manufacture comprising a computer usable medium having computer readable program code means embodied therein for causing resolution of at least a portion of a query, the computer readable program code means in said article of manufacture comprising computer readable program code means for causing a computer to effect an apparatus of claim 19.

55. A computer program product comprising a computer usable medium having computer readable program code means embodied therein for causing resolution of at least a portion of a query, the computer readable program code means in said computer program product comprising computer readable program code means for causing a computer to effect the elements of claim 37.

56. A program storage device readable by machine, tangibly embodying a program of instructions executable by the machine to perform method steps for resolving at least a portion of a query, said method steps comprising the steps of claim 1.

57. A method comprising:
querying at least one time variant object having at least one known attribute;
creating a first representation of said at least one time variant object in terms of said at least one known attribute;
building an index structure on said first representation; and
employing said index structure in resolving at least one query included in the step of querying.

58. An article of manufacture comprising a computer usable medium having computer readable program code means embodied therein for causing resolution of at least a portion of a query, the computer readable program code means in said article of manufacture comprising computer readable program code means for causing a computer to effect the steps of claim 57.
